(19) United States
(12) Patent Application Publication
(10) Pub. No.: US 2007/0113549 A1
(43) Pub. Date: May 24, 2007

(54) Hydrostatic drive system with division of the quantity of hydraulic fluid at the pump

(76) Inventors: Heinz-Gerhard Essig, Lonsee (DE); Norbert Ruckgauer, Huettisheim (DE)

Correspondence Address: SCULLY, SCOTT, MURPHY & PRESSER, P.C., 400 GARDEN CITY PLAZA, SUITE 300, GARDEN CITY, NY, 11530, US

(21) Appl. No.: 10/580,701

(22) PCT Filed: Nov. 10, 2004
(86) PCT No.: PCT/EP04/12724

§ 371 Date: May 25, 2006

(30) Foreign Application Priority Data
Dec. 2, 2003 (DE) 103 56 155.2

(51) Int. Cl. F16D 39/00

(52) U.S. Cl. 60/487

(57) ABSTRACT

A hydrostatic drive system consists of at least one hydraulic pump (100) and at least two hydraulic motors (104, 109, 125, 128, 131, 134, 137, 140). Said hydraulic pump (100) divides up its overall flow of hydraulic fluid over at least two partial flows of hydraulic fluid which are each delivered in a partial delivery line (101, 102) in a common cylinder drum (23) belonging to the hydraulic pump (100). A first hydraulic motor (104) driving a first drive line (105) is connected by its first connection (103) to the first connection (38) of the first partial delivery line (101) of the hydraulic pump (100), and by its second connection (107) to the second connection (56′) of the second partial delivery line (102) of said hydraulic pump (100). A second hydraulic motor (109) driving a second drive line (110) is connected by its first connection (108) to the first connection (56) of the second partial delivery line (102) of the hydraulic pump (100), and by its second connection (112) to the second connection (38′) of the first partial delivery line (101) of said hydraulic pump (100).

The invention relates to a hydrostatic drive system with division of the quantity of hydraulic fluid at the pump.

Hydraulic travelling drives which are designed for a cornering operation have, as is represented in EP 0 378 742 A2, two hydraulic circuits which are separate from one another, each hydraulic circuit consisting of a hydraulic pump and a hydraulic motor. In this way, it is possible to deliver separately, by two hydraulic pumps, the different quantities of hydraulic fluid for the two hydraulic motors in the case of cornering by the hydraulic travelling drive.

A hydraulic travelling drive according to EP 0 378 742 A2 is characterised by the difficulty of generating, by means of the two hydraulic pumps, the quantities of hydraulic fluid of equal magnitude, which are necessary in the case of straight-ahead travel, for the two hydraulic motors. Added to this is the fact that, in the case of straight-ahead travel by the hydraulic travelling drive, in the event of one drive line slipping or even spinning, the quantity of hydraulic fluid in the appertaining hydraulic circuit increases markedly, so that the hydraulic motor of the other drive line in each case, which is not slipping or spinning, is “bridged” hydraulically. In this way, the hydraulic travelling drive becomes inoperative.

The hydrostatic travelling drive in DE 198 33 942 A1 connects the two hydraulic circuits, which are connected in parallel in EP 0 378 742 A2, in series. There is thus obtained a single hydraulic circuit which is formed as a concatenation of the first hydraulic pump, the first hydraulic motor, the second hydraulic pump and the second hydraulic motor. This guarantees that a quantity of hydraulic fluid of equal magnitude is delivered in all the sections of the hydraulic circuit. If there is a risk of slipping or spinning in one drive line, because of the system no rise in the quantity of hydraulic fluid occurs in the hydraulic circuit. On the contrary, the slipping or spinning drive line is braked by the other drive line, which is not slipping or spinning, of the hydrostatic travelling drive.

What is disadvantageous about the hydrostatic travelling drive in DE 198 33 942 A1 is the use of two separate hydraulic pumps, especially as the same quantity of hydraulic fluid is delivered by both hydraulic pumps in the closed hydraulic circuit of the hydrostatic travelling drive.

The underlying object of the invention is therefore to further develop a hydrostatic travelling drive in such a way that, with hydraulic motors connected in series in a hydraulic circuit, use is made, in order to avoid slipping or spinning of one drive line, of a pump unit which is designed so as to be of substantially simpler construction than a pump unit consisting of two separate pumps.

The object of the invention is achieved by means of a hydrostatic drive system having the features in claim 1.

In the minimal configuration of the first form of embodiment, the hydraulic circuit consists of two drive lines which are each driven by a hydraulic motor, which motors are, in turn, supplied with a quantity of hydraulic fluid by a hydraulic pump. The hydraulic pump has two partial delivery lines which each deliver a partial flow of hydraulic fluid in a common cylinder drum belonging to the hydraulic pump, according to the invention, of the hydrostatic drive system according to the invention. The two partial delivery lines of the hydraulic pump, according to the invention, of the hydrostatic drive system according to the invention, assume the function of the two hydraulic pumps of the hydrostatic travelling drive in DE 198 33 942 A1 and are therefore connected, within the hydraulic circuit between the two hydraulic motors, in series with the latter in each case. In this way, possible slipping or spinning of one of the two hydraulic motors can be prevented.

By comparison with the hydrostatic travelling drive in DE 198 33 942 A1, there is a single-pump system. This is characterised by a smaller space for construction, in particular a smaller overall length, and reduced outlay on pipework. Compared to a two-pump system, the hydrostatic drive system according to the invention needs no distributor gear unit for coupling the individual pumps mechanically, a fact which once again reduces the space required for construction and makes outlay on wear-induced maintenance and inspection unnecessary.

Finally, it should be mentioned that, in applications with a high hydraulic power requirement, instead of one hydraulic pump, it is possible to connect a number of hydraulic pumps in parallel.

Advantageous refinements of the invention are indicated in the dependent claims.

In a second form of embodiment of the hydrostatic drive system according to the invention, the two drive lines are driven by two mechanically coupled hydraulic motors in each case. The connections, on the feeding-in and feeding-out sides, of the first and third hydraulic motors and also of the third and fourth hydraulic motors may be connected jointly, in each case, to a connection belonging to a partial delivery line of the hydraulic pump of the hydrostatic drive system according to the invention, while the other connections, in each case, of the first and third hydraulic motors and also of the second and fourth hydraulic motors are connected in each case, on the opposite connecting side of the hydraulic pump, to a connection belonging to one of the two partial delivery lines of the hydraulic pump of the hydrostatic drive system according to the invention. This guarantees that a self-contained hydraulic circuit which, in the event of slipping or spinning of the first or second drive line, ensures braking by the other drive line in each case, exists at least over the first and second hydraulic motors and also over the two partial delivery lines of the hydraulic pump.

In a third form of embodiment of the hydrostatic drive system according to the invention, which form of embodiment is based on the first form of embodiment of the hydrostatic drive system according to the invention, a third drive line is driven by a fifth hydraulic motor. The first and third drive lines are responsible, in each case, for driving the front right-hand wheel and left-hand wheel, or the front right-hand chain and left-hand chain, of the vehicle. The second drive line drives the rear wheel or rear chain. Since the first and fifth hydraulic motors are connected in parallel, and are each connected to the second hydraulic motor and the two partial delivery lines of the hydraulic pump in series to form a closed hydraulic circuit, slipping or spinning of the first or third drive line is braked by the second drive line, and slipping or spinning of the second drive line is braked by the first and third drive lines.

In the fourth form of embodiment of the hydrostatic drive system according to the invention, which form of embodiment is based on the third form of embodiment and, like the latter, has three drive lines, the first and third drive lines are driven by two mechanically coupled hydraulic motors in each case. The connections, on the feeding-in and feeding-out sides, of the first and third hydraulic motors driving the first drive line, and also of the fifth and sixth hydraulic motors driving the third drive line, may be connected jointly, in each case, in a manner analogous to the second form of embodiment, to a connection belonging to a partial delivery line of the hydraulic pump, while the other connections, in each case, of the first and third hydraulic motors and also of the fifth and sixth hydraulic motors may be connected separately, on the opposite connecting side of the hydraulic pump, to one connection, in each case, belonging to one of the two partial delivery lines of said hydraulic pump. This guarantees, as in the second form of embodiment, that, in the event of slipping or spinning of the first or third drive line, braking is ensured by the second drive line, while in the case of slipping or spinning of the second drive line, braking by the first and third drive lines occurs.

In the fifth form of embodiment of the hydrostatic drive system according to the invention, the second hydraulic motor driving the second drive line is, in contrast to the third and fourth forms of embodiment, connected by its two connections, in each case, to the two connections of the first partial delivery line of the hydraulic pump. In the event of slipping of the second hydraulic motor, limitation of the rotational speed, and thereby avoidance of slipping of the second hydraulic motor, occurs through the fact that, if the first drive line is not slipping, the quantity of hydraulic fluid required for slipping is not diverted from the first hydraulic motor, which is likewise supplied by the first partial delivery line of the hydraulic pump, to the second hydraulic motor.

The sixth form of embodiment of the hydrostatic drive system according to the invention is intended for four drive lines. In this case, the fifth hydraulic motor, which drives the third drive line, is connected hydraulically in parallel with the first hydraulic motor driving the first drive line, while the seventh hydraulic motor, which drives the fourth drive line, is connected in parallel with the second hydraulic motor driving the second drive line. In the fifth form of embodiment of the hydrostatic drive system according to the invention, the first and fifth hydraulic motors are connected in series, in a manner analogous to the first form of embodiment, with the second and seventh hydraulic motors via the two partial delivery lines of the hydraulic pump in a closed hydraulic circuit. In this way it is possible, if slipping or spinning of the first, second, third or fourth drive line occurs, to prevent braking by the other two hydraulic motors which are each connected in series with the slipping or spinning hydraulic motor.

In the seventh form of embodiment of the hydraulic drive system according to the invention, which form of embodiment is based on the sixth form of embodiment, all four drive lines are driven by two mechanically coupled hydraulic motors. The interconnection of the hydraulic motors, of which there are eight in all, with the two connections of the two partial delivery lines of the hydraulic pump takes place in a manner analogous to the second and third forms of embodiment and thereby prevents slipping or spinning of one of the four drive lines.

In the case of straight-ahead travel of the vehicle, equalising flows between the two working conduits may be realised via activated 2/2-way valves in the event of non-slipping of a drive line, in order to guarantee equalisation of the differential in the case of cornering, between the two working conduits which are connected, on the feeding-in and feeding-out sides in each case, to the two connections of the two partial delivery lines of the hydraulic pump. The said 2/2-way valves may also be integrated in the hydraulic pump on the feeding-in and feeding-out sides.

The forms of embodiment of the invention are represented in the drawings and will be described in greater detail below.

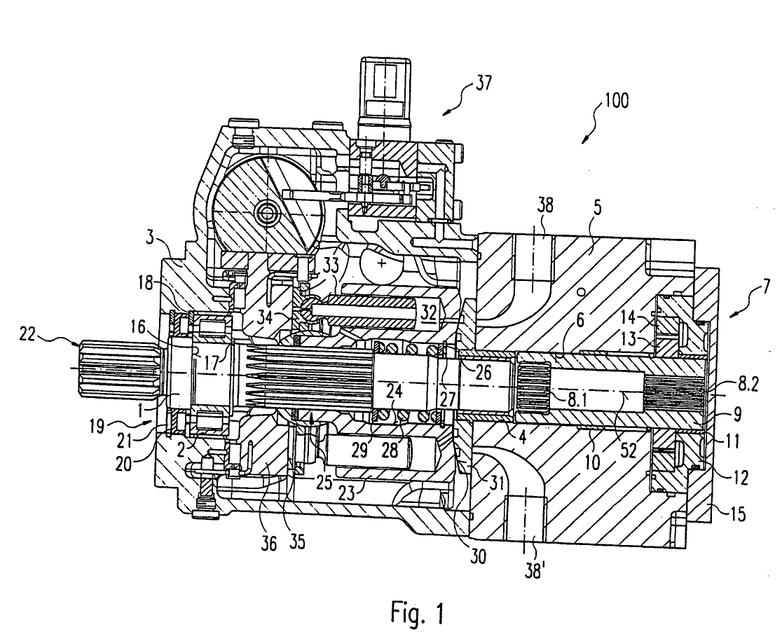

FIG. 1 shows a longitudinal section through a hydraulic pump belonging to a hydraulic drive system according to the invention with division of the quantity of hydraulic fluid at the pump;

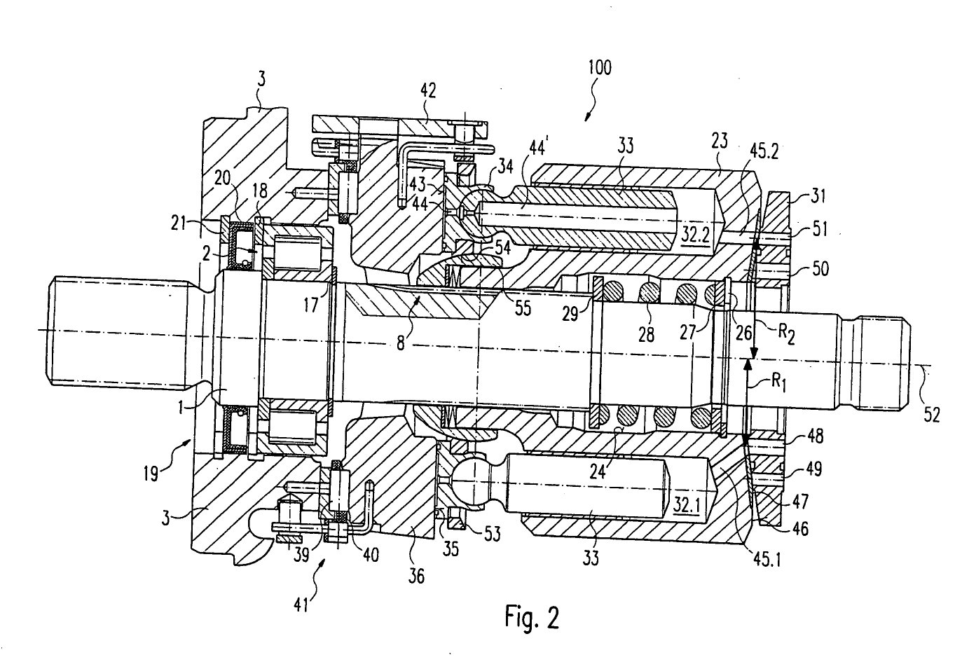

FIG. 2 shows an enlarged representation of a detail of the longitudinal section of the hydraulic pump of a hydraulic drive system according to the invention with division of the quantity of hydraulic fluid at the pump;

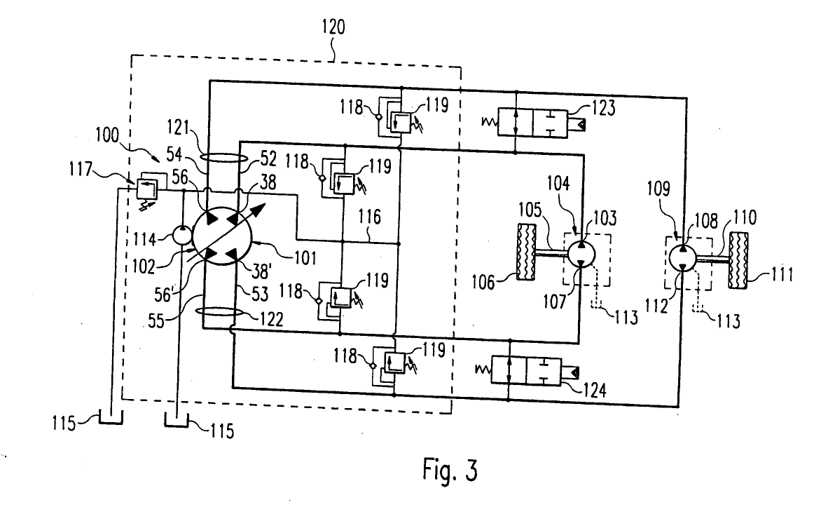

FIG. 3 shows a circuit diagram of a first form of embodiment of a hydraulic drive system according to the invention with division of the quantity of hydraulic fluid at the pump;

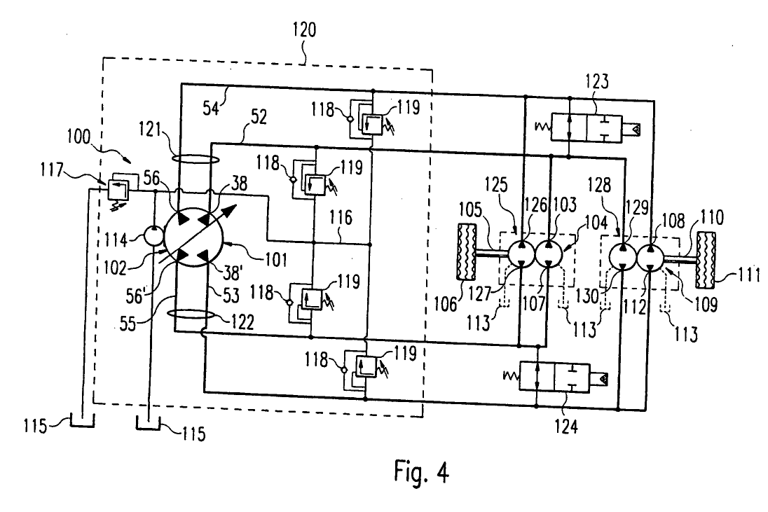

FIG. 4 shows a circuit diagram of a second form of embodiment of a hydraulic drive system according to the invention with division of the quantity of hydraulic fluid at the pump;

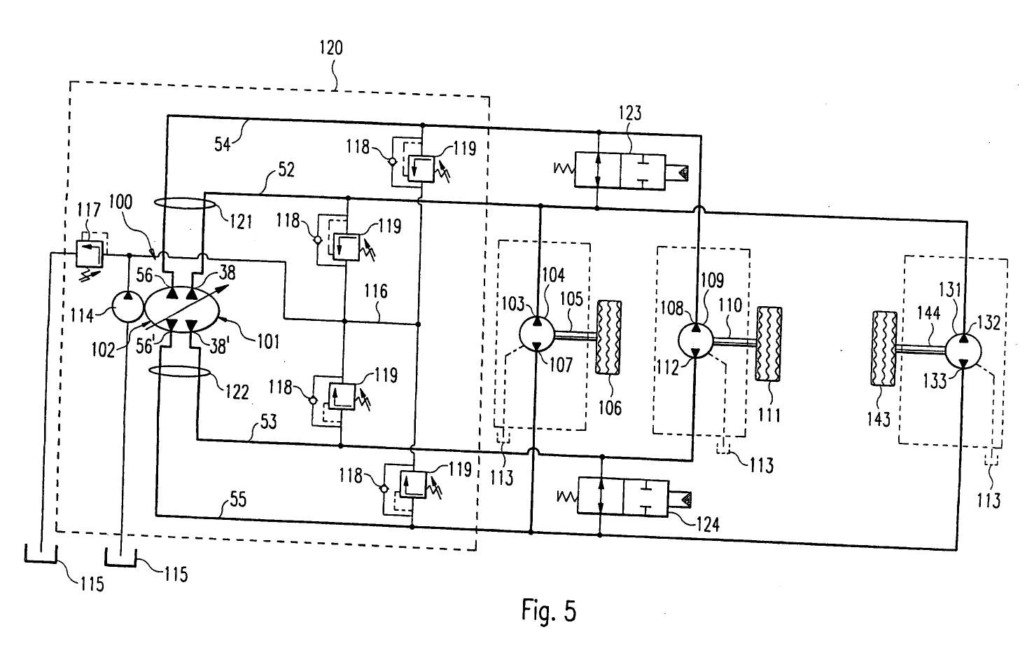

FIG. 5 shows a circuit diagram of a third form of embodiment of a hydraulic drive system according to the invention with division of the quantity of hydraulic fluid at the pump;

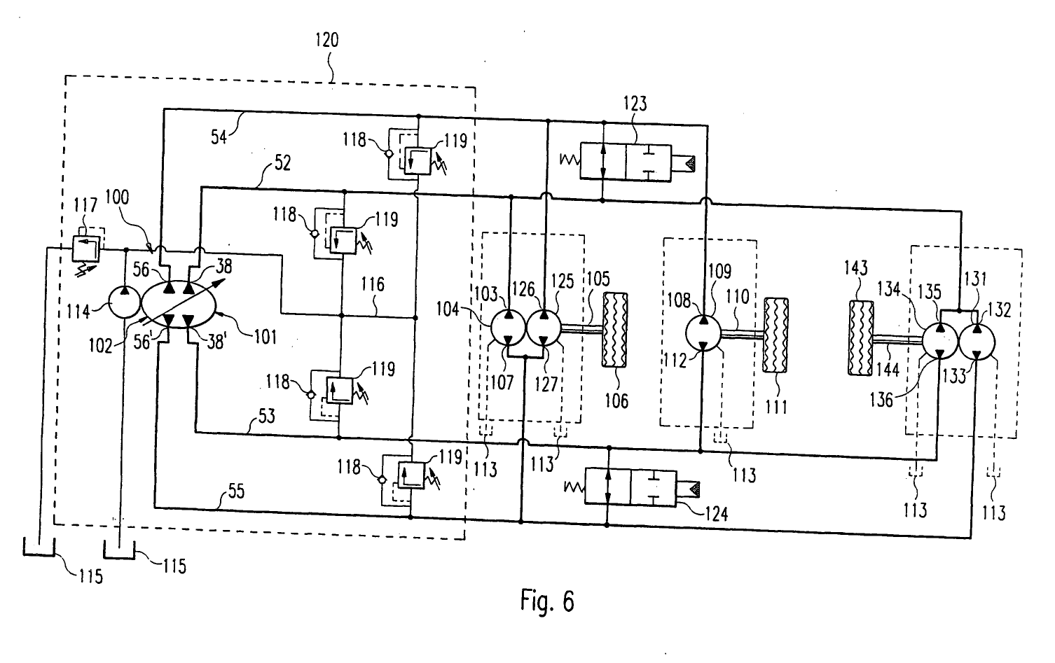

FIG. 6 shows a circuit diagram of a fourth form of embodiment of a hydraulic drive system according to the invention with division of the quantity of hydraulic fluid at the pump;

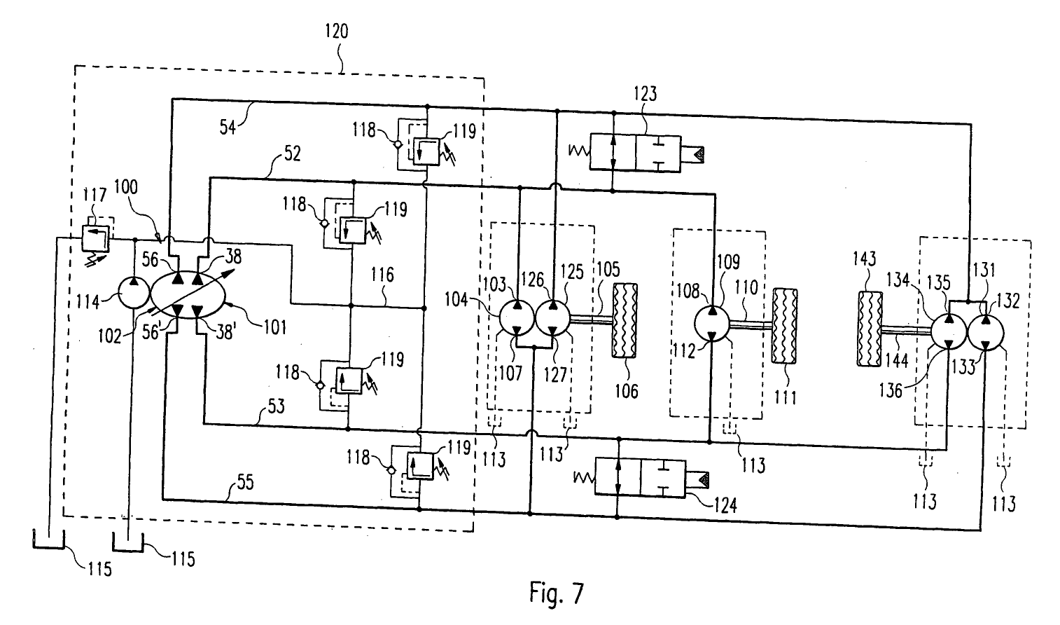

FIG. 7 shows a circuit diagram of a fifth form of embodiment of a hydraulic drive system according to the invention with division of the quantity of hydraulic fluid at the pump;

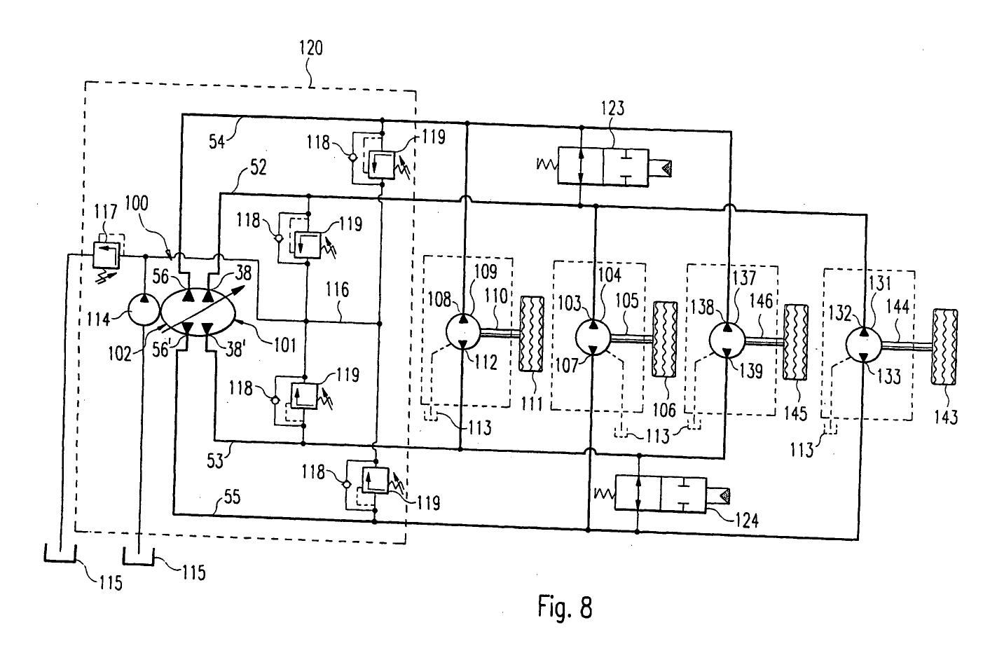

FIG. 8 shows a circuit diagram of a sixth form of embodiment of a hydraulic drive system according to the invention with division of the quantity of hydraulic fluid at the pump; and

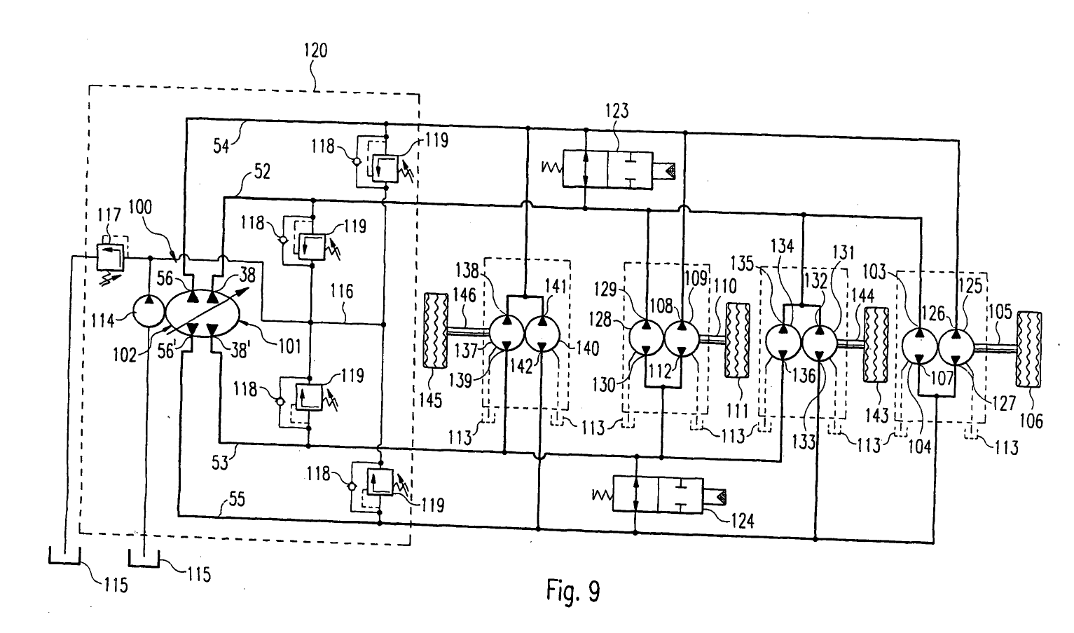

FIG. 9 shows a circuit diagram of a seventh form of embodiment of a hydraulic drive system according to the invention with division of the quantity of hydraulic fluid at the pump.

An exemplified embodiment of the hydraulic pump 100 of the hydraulic drive system according to the invention with division of the quantity of hydraulic fluid at the pump will be described below with reference to FIGS. 1 and 2.

The longitudinal section represented in FIG. 1 through the hydraulic pump according to the invention shows how the common drive shaft 1 is mounted by means of a roller bearing 2 at one end of a pump housing 3. Said common drive shaft 1 is additionally mounted in a plain bearing 4 which is disposed in a connecting plate 5 which closes the pump housing 3 at the opposite end.

Constructed in said connecting plate 5 is a clearance 6 which passes right through the connecting plate in the axial direction, in which the plain bearing 4 is disposed on the one hand, and through which the common drive shaft 1 passes on the other. On that side of the connecting plate 5 which faces away from the pump housing 3, the auxiliary pump 7 is inserted in a radial widened portion in the clearance 6. For the purpose of driving the auxiliary pump 7, the common drive shaft 1 has a tooth system 8.1 which is in engagement with the corresponding tooth system on an auxiliary pump shaft 9. Said auxiliary pump shaft 9 is mounted in the clearance 6 by means of a first auxiliary pump plain bearing 10 and in the auxiliary pump connecting plate 12 by means of a second auxiliary pump plain bearing 11.

Disposed on the auxiliary pump shaft 9 is a gear wheel 13 which is in engagement with an internal geared wheel 14. Said internal geared wheel 14, which is disposed in the auxiliary pump connecting plate 12 in a rotatable manner, is likewise driven, via the gear wheel 13, by the auxiliary pump shaft 9 and thereby ultimately by the common drive shaft 1. The suction-side and pressure-side connections for the auxiliary pump 7 are constructed in the auxiliary pump connecting plate 12. The auxiliary pump 7 is fixed in position in the radial widened portion of the clearance 6 in the connecting plate 5 by a cover 15 which is mounted on said connecting plate 5.

The inner race of the roller bearing 2 is fixed in position in the axial direction on the common drive shaft 1. Said inner race rests, on one side, against a collar 16 on the common drive shaft 1 and, on the other side, is held in this axial position by a retaining ring 17 which is inserted in a groove in said common drive shaft 1. The axial position of the roller bearing 2 with respect to the pump housing 3 is determined by the retaining ring 18 which is inserted in a circumferential groove in the shaft aperture 19. A sealing ring 20 and, finally, another retaining ring 21 are also disposed in said shaft aperture 19 in the direction of the outer side of the pump housing 3, said retaining ring 21 being inserted in a circumferential groove in said shaft aperture 19.

A driving tooth system 22, via which the hydraulic pump is driven by a driving engine which is not represented, is constructed on that end of the common drive shaft 1 which protrudes from the pump housing 3.

Disposed in the interior of said pump housing 3 is a cylinder drum 23 which has a central through-aperture 24 through which the common drive shaft 1 passes. Said cylinder drum 23 is connected, via another driving tooth system 25, to the common drive shaft 1 in a manner secured against torsion but displaceable in the axial direction, so that a rotating movement of the common drive shaft 1 is transmitted to the cylinder drum 23.

Another retaining ring 26, against which a first supporting washer 27 rests, is inserted in a groove constructed in the central through-aperture 24. Said first supporting washer 27 forms a first spring bearing for a compression spring 28. A second spring bearing for said compression spring 28 is formed by a second supporting washer 29 which is supported against the end face of the additional driving tooth system 25. The compression spring 28 thereby exerts a force, in the opposite axial direction in each case, on the common drive shaft 1 on the one hand, and on the cylinder drum 23 on the other hand. The common drive shaft 1 is loaded in such a way that the outer race of the roller bearing 2 is supported against the retaining ring 18.

In the opposite direction, the compression spring 28 acts on the cylinder drum 23 which is held in abutment against a control plate 31 by a spherical depression 30 constructed on the end face of the cylinder drum 23. Said control plate 31, in turn, rests against the connecting plate 5 in a sealing manner with the side that faces away from the cylinder drum 23. Said cylinder drum 23 is centred by means of the spherical depression 30, which corresponds with a suitable spherical contour on the control plate 31.

The position of the control plate 31 in the radial direction is fixed by the outer periphery of the plain bearing 4. For this purpose, said plain bearing 4 is inserted only partially in the clearance 6 in the connecting plate 5.

Cylinder bores 32, in which pistons 33 which are longitudinally displaceable in said cylinder bores 32 are disposed, are incorporated in the cylinder drum 23 in a manner distributed over a common pitch circle. At the end that faces away from the spherical depression 30, the pistons 33 partially protrude from the cylinder drum 23. At this end, there is fastened to each of the pistons 33 a sliding shoe 34 via which said pistons 33 are supported on a running surface 35 on a swivelling disc 36.

In order to produce a movement of stroke of the pistons 33, the angle which the running surface 35 of the swivelling disc 36 forms with the central axis is variable. For this purpose, the swivelling disc 36 can be adjusted in its inclination by the adjusting arrangement 37. Said swivelling disc 36 is mounted in the pump housing 3 in roller bearings in order to absorb the forces which are transmitted to the swivelling disc 36 by the sliding shoes 34.

A first connection 38, a second connection 38′, a third connection 56 and a fourth connection 56′ are provided in the connecting plate 5 for the purpose of connecting the hydraulic pump 100 to a first hydraulic circuit and to a second hydraulic circuit. Represented diagrammatically in FIG. 1 are a first connection 38 and a second connection 38′ which can be connected via the control plate 31, in a manner which is not shown, to the cylinder bores 32 and form a first partial delivery line 101 of the hydraulic pump 100 for a first hydraulic circuit. The third and fourth connections 56 and 56′, which are not represented in FIG. 1, can be connected to the cylinder bores 32 in an analogous manner, and form the second partial delivery line 102 of the hydraulic pump 100 for a second hydraulic circuit.

An enlarged representation of the components which interact in the interior of the pump housing 3 is represented in FIG. 2.

On its side that faces away from the running surface 35, the swivelling disc 36 is supported on a cylindrical-roller bearing 39, the cylindrical rollers of which are held by a bearing cage 40. In order to ensure a reliable return of the cylindrical rollers into their original location after each swivelling movement, the bearing cage 40 is fastened to a retaining mechanism 41, by means of which said bearing cage 40 performs a controlled movement both when swivelling out and also when swivelling back.

For the purpose of performing a swivelling movement, the swivelling disc 36 is coupled to a sliding block 42 which rotates said swivelling disc 36, in a manner which is not represented, about an axis which lies in the plane of the drawing.

The cylinder bores, which are designated generally by 32 in FIG. 1, are subdivided into a first group of cylinder bores 32.1 and a second group of cylinder bores 32.2. As has already been explained briefly in the remarks on the subject of FIG. 1, a sliding shoe 34 is disposed on each of the pistons 33 at the end that faces away from the control plate 31. Said sliding shoe 34 is fastened, by means of a clearance, to a spherical head of the piston 33, so that the sliding shoe 34 is fixed in position on said piston 33 in a movable manner, and pulling and pressing forces can be transmitted.

A sliding surface 43, by which the sliding shoe 34, and thereby the piston 33, is supported on the running surface 35 of the swivelling disc 36, is constructed on said sliding shoe 34. Constructed in the sliding surface 43 are lubricating-oil grooves which are connected to the cylinder bores 32 constructed in the cylinder drum 23 via a lubricating-oil duct 44 which is constructed in the sliding shoe 34 and is continued in the form of a lubricating-oil bore 44′ in the piston 33.

Because the sliding shoes 34 are supported against the running surface 35, the pistons 33 perform a movement of stroke when the common drive shaft 1 rotates, as a result of which movement the pressure medium located in the cylinder spaces in the cylinder drum 23 is pressurised. Some of this pressure medium passes out at the sliding surface 43 and thus forms a hydrodynamic bearing for the sliding shoe 34 on the running surface 35.

In order to convey the pressure medium from the cylinder spaces into a first or second hydraulic circuit, first connecting ducts 45.1 and second connecting ducts 45.2 are connected, in each case, to the cylinder bores of the first group 32.1 and the cylinder bores of the second group 32.2 respectively. The first and second connecting ducts 45.1 and 45.2 extend from the cylinder bores of the first group 32.1 and the cylinder bores of the second group 32.2 respectively, to the spherical depression 30 which is constructed on one end face 46 of the cylinder drum 23.

A first control pocket 48 and a second control pocket 49, which pass through the control plate 31 in the axial direction, are constructed in said control plate 31 which is connected to the connecting plate 5 in a manner secured against torsion.

A third control pocket 50 and a fourth control pocket 51 are also preferably constructed in the control plate 31. While the first and third control pockets 48 and 50 are connected, via the connecting plate 5, to working conduits 52 and 53, respectively, of the first hydraulic circuit, the second control pocket 49 and the fourth control pocket 51 are connected, in a corresponding manner, to the working conduits 54 and 55, respectively, of the second hydraulic circuit.

The first and third control pockets 48 and 50 are at an identical first distance R₁′ from the longitudinal axis 52 of the cylinder drum 23 which is smaller than the second distance R₂′ from the longitudinal axis 52, which distance is again identical for the second control pocket 49 and the fourth control pocket 51. In the course of one revolution of the common drive shaft 1, the first connecting ducts 45.1 are connected in turn to the first control pocket 48 and the third control pocket 50, so that, because of the movement of stroke of the pistons 33 disposed in the cylinder bores 32.1 of the first group, the pressure medium is sucked in, for example via the third control pocket 50, and pumped into that working conduit 52 or 53 of the first hydraulic circuit which is on the pressure side, via the first control pocket 48. For this purpose, the first connecting ducts 45.1 open onto the end face 46 of the cylinder drum 23 at a first distance R₁ from the longitudinal axis 52 of the cylinder drum 23 which corresponds to the first distance R₁′ of the first and third control pockets, 48 and 50 respectively, from said longitudinal axis 52 of the cylinder drum 23.

In the exemplified embodiment represented, the first connecting ducts 45.1 are disposed in the cylinder drum 23 in such a way that they have a radial component of direction as a result of which the first distance R₁ of the outlet on the end face 46 is smaller than the distance on the opposite side of the first connecting ducts 45.1. The second connecting ducts 45.2 accordingly open onto the end face 46 of the cylinder drum 23 at a second distance R₂ which corresponds with a second distance R₂′ of the second and fourth control pockets 49 and 51 from the longitudinal axis 52. In the course of one revolution of the common drive shaft 1, the cylinder bores of the second group 32.2 are thereby alternately connected to the second and fourth control pockets 49 and 51 via the second connecting ducts 32.2.

In order to prevent the sliding shoes 34 from lifting off the running surface 35 of the swivelling disc 36 during a suction stroke, a holding-down plate 53 is provided, which engages round the sliding shoes 34 at an offset which is provided for that purpose. Said holding-down plate 53 has a spherical central clearance 54 with which it is supported against a supporting head 55 which is disposed on that end of the cylinder drum 23 which faces away from the end face 46.

FIG. 3 shows a first form of embodiment of a hydraulic drive system according to the invention with division of the quantity of hydraulic fluid at the pump, which form of embodiment uses the hydraulic pump 100 according to the invention which has been described above, with two partial delivery lines 101 and 102.

The connection 38 of the first partial delivery line 101 of the hydraulic pump 100 according to the invention is connected to the first connection 103 of the first hydraulic motor 104 via the first working conduits 52. Said first hydraulic motor 104 drives a first wheel 106 of a vehicle via a first drive line 105. The second connection 107 of the first hydraulic motor 104 is connected, via the working conduit 55, to the second connection 56′ of the second partial delivery line of the hydraulic pump 100 according to the invention. The first connection 56 of the second partial delivery line 102 of the hydraulic pump 100 according to the invention is connected to the first connection 108 of the second hydraulic motor 109 via the working conduit 54. Said second hydraulic motor 109 drives a second wheel 111 of a vehicle via a second drive line 111. The second connection 112 of the second hydraulic motor is connected, via the working conduit 53, to the second connection 38′ of the first partial delivery line 101 of the hydraulic pump 100 according to the invention. The leakage volume of the first and second hydraulic motors 104 and 109 is connected, in each case, to a hydraulic tank 113 for the purpose of discharging leaking hydraulic fluid.

The hydraulic pump 100, which is adjustable in the quantity of its hydraulic fluid, is mechanically coupled, with its two partial delivery lines 101 and 102, to an auxiliary pump 114 via a drive shaft which is not represented in FIG. 3. Said auxiliary pump 114 delivers a hydraulic fluid into a feeding conduit 116 from a tank 115. The pressure of the hydraulic fluid in said feeding conduit 116 is set to a specific level via a pressure-limiting valve 117. If there is a drop in pressure in the working conduits 52, 53, 54 and/or 55, hydraulic fluid is fed into the working conduit 52, 53, 54 and/or 55 afterwards from the feeding conduit 116 via a non-return valve 117 in each case. If an excess pressure occurs in the working conduits 52, 53, 54 and/or 55, said excess pressure is discharged into the feeding conduit 116 in known manner via an excess-pressure valve 118 in each case from the working conduit 52, 53, 54 and/or 55 which is carrying an excess pressure. The hydraulic pump 100 with its two partial delivery lines 101 and 102, the auxiliary pump 114, the pressure-limiting valve 117 and also the four non-return valves 118 and the four excess-pressure valves 119 together form a pump unit 120.

The two partial delivery lines 101 and 102 of the hydraulic pump 100 according to the invention and the two hydraulic motors 104 and 109 form, together with the working conduits 52, 53, 54 and 55, a single hydraulic first circuit. Because of this series connection of the first hydraulic motor 104 and second hydraulic motor 109 and also of the two partial delivery lines 101 and 102 of the hydraulic pump 100, a flow of hydraulic fluid of equal magnitude flows in all the working conduits 52, 53, 54 and 55. Possible slipping or spinning of the wheel 106 or 111 in the case of lack of adhesion of said wheel 106 or 111 on the surface of the carriageway, and an accompanying rise in the flow of hydraulic fluid in the first hydraulic motor 104 or second hydraulic motor 109, is eliminated, since the other, non-slipping or non-spinning wheel 111 or 106, in each case, limits the level of the flow of hydraulic fluid in the hydraulic circuit to the value that corresponds to the normal operating situation. In this way, the slipping or spinning first or second hydraulic motor 104 or 109 is braked by the non-slipping and non-spinning second or first hydraulic motor 109 or 104. Hydraulic “bridging” of the non-slipping and non-spinning first or second hydraulic motor 104 or 109 by the slipping or spinning second or first hydraulic motor 109 or 104 is consequently not possible in the case of this configuration.

Because of the different paths of the wheels, cornering operations lead to asymmetrical pressure conditions at the first or second hydraulic motor 104 or 109. Pressure differences of this kind between the working conduits 52 and 54 or 53 and 55 when the vehicle is cornering may be bridged by the interpolation of a 2/2-way valve 123 and 124 in each case. If these 2/2-way valves are switched off by the control electronics of the vehicle in the case of cornering and when no slipping of a wheel 106 or 111 occurs, the particular 2/2-way valve is switched into the open condition, in which the particular working conduits 52 and 54 or 53 and 55 are hydraulically connected to one another. In this way, hydraulic equalising flows take place between the working conduits 52 and 54 or 53 and 55 for the purpose of reducing the pressure difference between said working conduits 52 and 54 or 53 and 55.

A second form of embodiment of the hydraulic drive system according to the invention with division of the quantity of hydraulic fluid at the pump, which form of embodiment uses the hydraulic pump 100 with the two partial delivery lines 101 and 102, is represented in FIG. 4.

The second form of embodiment in FIG. 4 is based on the first form of embodiment in FIG. 3, so that in the following description, as also in all the descriptions belonging to the forms of embodiment which will now follow, the same reference symbols will be used for the same features and the description thereof will not be repeated.

In the second form of embodiment of the hydraulic drive system according to the invention, the first drive line 105 is driven, as well as by the first hydraulic motor 104, by a third hydraulic motor 125 which is mechanically coupled to said first hydraulic motor 104. Said third hydraulic motor 125 is connected by its first connection 126, via the working conduit 54, to the first connection 56 of the second partial delivery line 102 of the hydraulic pump 100, and by its second connection 125, via the working conduit 55, to the second connection 56′ of the second partial delivery line 102 of said hydraulic pump 100. A fourth hydraulic motor 128, which is mechanically coupled to the second hydraulic motor 109 and drives, with the latter, the second drive line 110, is connected by its first connection 129, via the working conduit 52, to the first connection 38 of the first partial delivery line 101 of the hydraulic pump 100, and by its second connection 130, via the working conduit 53, to the second connection 38′ of the first partial delivery line 101 of said hydraulic pump 100.

Slipping or spinning of the first drive line 105 or of the second drive line 110 is realised, in a manner analogous to the first form of embodiment, by the braking effect of the closed hydraulic circuit consisting of the first hydraulic motor 104, the second hydraulic motor 109, the two partial delivery lines 101 and 102 of the hydraulic pump 100 and the working conduits 52, 53, 54 and 55. A pair of hydraulic motors 104 and 126 or 109 and 128 which may possibly slip or spin is braked by the other pair of hydraulic motors, 109 and 128 or 104 and 126 respectively, which is not slipping or spinning. The fact that the third hydraulic motor 125 and the fourth hydraulic motor 128 are not interconnected cross-wise with the first and second partial delivery lines 101 and 102 of the hydraulic pump 100 is of no relevance for preventing the slipping or spinning of the first or second drive line 105 or 110, since braking takes place via the hydraulic series connection of the first or second hydraulic motor 104 or 109.

A third form of embodiment of the hydraulic drive system according to the invention with division of the quantity of hydraulic fluid at the pump, which form of embodiment uses the hydraulic pump 100 according to the invention with the two partial delivery lines 101 and 102, is represented in FIG. 5.

The third form of embodiment in FIG. 5, which is based on the first form of embodiment in FIG. 3, has a fifth hydraulic motor 131 which drives a third drive line 144 connected to a wheel 143. The first and third drive lines 105, 144 form, respectively, the left-hand and right-hand front drives of the vehicle, while the second drive line 110 represents the rear drive of said vehicle. The fifth hydraulic motor 131 is connected by its first connection 132, via the working conduit 52, to the first connection 38 of the first partial delivery line 101 of the hydraulic pump 100, and by its second connection 133, via the working conduit 55, to the second connection 56′ of the second partial delivery line 102 of said hydraulic pump 100. The fifth hydraulic motor 131 is consequently connected in parallel, hydraulically speaking, with the first hydraulic motor 104.

Possible slipping or spinning of the first hydraulic motor 104 or of the fifth hydraulic motor 131 is braked by the non-slipping and non-spinning second hydraulic motor 109, while possible slipping or spinning of said second hydraulic motor 109 is braked by the non-slipping and non-spinning first and fifth hydraulic motors 104 and 131 in a manner analogous to the way in which the first and second forms of embodiment function.

A fourth form of embodiment of the hydraulic drive system according to the invention with division of the quantity of hydraulic fluid at the pump, which form of embodiment uses the hydraulic pump 100 with the two partial delivery lines 101 and 102, is represented in FIG. 6.

The fourth form of embodiment in FIG. 6, which is based on the third form of embodiment in FIG. 5, has a third hydraulic motor 125 which is mechanically coupled to the first hydraulic motor 104 and drives the first drive line 105 jointly with the latter, and a sixth hydraulic motor 134 which is mechanically coupled to the fifth hydraulic motor 131 and drives the third drive line 144 jointly with the latter.

The third hydraulic motor 125 is interconnected hydraulically with its first connection 126 and with its second connection 127 in a manner entirely analogous to the second form of embodiment of the hydraulic pump 134. The sixth hydraulic motor 134 is connected by its first connection 135, via the working conduit 52, to the first connection 38 of the first partial delivery line 101 of the hydraulic pump 100, and by its second connection 136, via the working conduit 53, to the second connection 38′ of the first partial delivery line 101 of said hydraulic pump 100.

Slipping or spinning of the second drive line 110, and thereby of the second hydraulic motor 109, is braked by the non-slipping and non-spinning first drive line 105 and the first and third hydraulic motors 104 and 125 coupled thereto and by the non-slipping and non-spinning third drive line 144 and the fifth and sixth hydraulic motors 131 and 134 coupled thereto. On the other hand, slipping or spinning of the first drive line 105 and of the first and third hydraulic motors 104 and 105 coupled thereto, or slipping or spinning of the third drive line 144 and of the fifth and sixth hydraulic motors 131 and 134 coupled thereto, is braked by the non-slipping and non-spinning second drive line 110 and the second hydraulic motor 109 coupled thereto. What has been stated in the description of the second form of embodiment applies to the non-crosswise interconnection of the third and sixth hydraulic motors 125 and 134 with the two partial delivery lines 101 and 102 of the hydraulic pump 100.

A fifth form of embodiment of the hydraulic drive system according to the invention with division of the quantity of hydraulic fluid at the pump, which form of embodiment uses the hydraulic pump 100 with the two partial delivery lines 101 and 102, is represented in FIG. 7.

Unlike the fourth form of embodiment in FIG. 6, the second hydraulic motor 109 in the fifth form of embodiment in FIG. 7 is connected by its first connection 108 to the first connection 38 of the first partial delivery line 101 of the hydraulic pump 100, and by its second connection 112, via the working conduit 53, to the second connection 38′ of the first partial delivery line 101 of said hydraulic pump 100. The first connection 132 of the fifth hydraulic motor 131 and the first connection 135 of the sixth hydraulic motor 134 is not connected, as in the fourth form of embodiment, to the first connection 38 of the first partial delivery line 101, but to the first connection 56 of the second partial delivery line 102 of the hydraulic pump 100.

In spite of the non-crosswise interconnection of the second hydraulic motor 109 with the two partial delivery lines 101 and 102 of the hydraulic pump 100, slipping or spinning of the said second hydraulic motor 109 is braked by the non-slipping and non-spinning first hydraulic motor 104 or the non-slipping and non-spinning sixth hydraulic motor 134. That is to say, the first connection 108 of the second hydraulic motor 109 receives the same quantity of hydraulic fluid as before from the first connection 38 of the first partial delivery line 101 of the hydraulic pump 100, since the first connection 103 of the first hydraulic motor 104 draws the same quantity of hydraulic fluid as before from said first connection 38 of the first partial delivery line 101 of said hydraulic pump 100. In an analogous manner, the second connection 112 of the second hydraulic motor 109 receives the same quantity of hydraulic fluid as before from the second connection 38′ of the first partial delivery line 101, since the second connection 136 of the sixth hydraulic motor 134 draws the same quantity of hydraulic fluid as before from said second connection 38′ of the first partial delivery line 101 of the hydraulic pump 100.

A sixth form of embodiment of the hydraulic drive system according to the invention with division of the quantity of hydraulic fluid at the pump, which form of embodiment uses the hydraulic pump 100 with the two partial delivery lines 101 and 102, is represented in FIG. 8.

On the basis of the third form of embodiment in FIG. 5, in which the first and fifth hydraulic motors 104 and 131 are connected in parallel, in the sixth form of embodiment in FIG. 8, a seventh hydraulic motor 137 is connected in parallel with the second hydraulic motor 109. The first connection 138 of the seventh hydraulic motor 137 is connected, via the working conduit 54, to the first connection 56 of the second partial delivery line 102 of the hydraulic pump 100, and by its second connection 139, via the working conduit 53, to the second connection 38′ of the first partial delivery line 101 of said hydraulic pump 100. This seventh hydraulic motor 137 drives a fourth drive line 146 connected to a wheel 145.

Slipping or spinning of the first drive line 105, and thereby of the first hydraulic motor 104, or slipping or spinning of the fifth hydraulic motor 131, which is connected in parallel, and thereby of the third drive line 144, is prevented by the non-slipping and non-spinning second drive line 110 and the second hydraulic motor 109 coupled thereto, and by the non-slipping and non-spinning fourth drive line 146 and the seventh hydraulic motor 137 coupled thereto, since the first hydraulic motor 104 and the fifth hydraulic motor 131, which is connected in parallel therewith, are connected in series, via the closed hydraulic circuit, with the second hydraulic motor 109 and the seventh hydraulic motor 137, which is connected in parallel therewith.

A seventh form of embodiment of the hydraulic drive system according to the invention with division of the quantity of hydraulic fluid at the pump, which form of embodiment uses the hydraulic pump 100 with the two partial delivery lines 101 and 102, is represented in FIG. 9.

On the basis of the sixth form of embodiment in FIG. 8, the first hydraulic motor 104 is mechanically coupled, in a manner analogous to the second form of embodiment in FIG. 4, to the third hydraulic motor 125 for the purpose of driving the first drive line 110, the second hydraulic motor 109 is mechanically coupled, in a manner analogous to the second form of embodiment in FIG. 4, to the fourth hydraulic motor 128 for the purpose of driving the second drive line 105, the fifth hydraulic motor 131 is mechanically coupled, in a manner analogous to the fourth form of embodiment in FIG. 6, to the sixth hydraulic motor 134 for the purpose of driving the third drive line 144, and the seventh hydraulic motor 137 is mechanically coupled to the eighth hydraulic motor for the purpose of driving the fourth drive line 146. Said eighth hydraulic motor 140 is connected by its first connection 141, via the working conduit 54, to the first connection 56 of the second partial delivery line 102 of the hydraulic pump 100, and by its second connection 142, via the working conduit 55, to the second connection 56′ of the second partial delivery line 102 of said hydraulic pump 100.

If slipping or spinning of the first, second, fifth or seventh hydraulic motor 104, 109, 131 or 137 occurs, what has been stated in the description of the sixth form of embodiment applies in an analogous manner. Non-crosswise hydraulic interconnection of the third, fourth, sixth and eighth hydraulic motors 125, 128, 134 and 140 with the two partial delivery lines 101 and 102 of the hydraulic pump 100 does not result, if slipping or spinning of the third, fourth, sixth and/or eighth hydraulic motors 125, 128, 134 and/or 140 occurs, in braking of the particular hydraulic motor failing to occur, since the third, fourth, sixth and eighth hydraulic motors 125, 128, 134 and 140 are mechanically coupled, in each case, to the first, second, fifth and seventh hydraulic motors 104, 109, 131 and 137, the braking of which is ensured, in the event of slipping or spinning, because of the cross-wise hydraulic interconnection with the two partial delivery lines 101 and 102 of the hydraulic pump 100.

The invention is not limited to the forms of embodiment represented. The elements described can be combined with one another in any desired manner within the scope of the invention. In this connection, attention may be drawn, in particular, to the hydraulic interconnection which is complementary to the hydraulic interconnection of the hydraulic motors 104, 109, 125, 128, 131, 134, 137 and 140 in the second form of embodiment in FIG. 4, the fourth form of embodiment in FIG. 6, the fifth form of embodiment in FIG. 7 and the eighth form of embodiment in FIG. 9, and in which, instead of the first connections 103, 108, 126, 129, 132, 138 and 141, the second connections 107, 112, 127, 130, 133, 136, 139 and 140 are connected to one another hydraulically in each case.

1. Hydrostatic drive system having at least one hydraulic pump and at least two hydraulic motors, wherein said hydraulic pump divides up its overall flow of hydraulic fluid over at least two partial flows of hydraulic fluid which are each delivered in a partial delivery line in a common cylinder drum belonging to the hydraulic pump, and wherein at least one first hydraulic motor driving a first drive line is connected by its first connection to the first connection of the first partial delivery line of the hydraulic pump, and by its second connection to the second connection of the second partial delivery line of said hydraulic pump, and at least one second hydraulic motor driving a second drive line is connected by its first connection to the first connection of the second partial delivery line of the hydraulic pump, and by its second connection to the second connection of the first partial delivery line of said hydraulic pump.

2. Hydrostatic drive system according to claim 1, wherein each connection of the hydraulic pump is connected to the connection of at least one hydraulic motor.

3. Hydrostatic drive system according to claim 1, wherein either one hydraulic motor or a number of hydraulic motors which are mechanically coupled to one another with the aid of a common driving axle drive a drive line.

4. Hydrostatic drive system according to claim 3, wherein a third hydraulic motor, which drives the first drive line in a manner mechanically coupled to the first hydraulic motor, is connected by its first connection to the first connection of the second partial delivery line of the hydraulic pump, and by its second connection to the second connection of the second partial delivery line of said hydraulic pump, and a fourth hydraulic motor, which drives the second drive line in a manner mechanically coupled to the second hydraulic motor, is connected by its first connection to the first connection of the first partial delivery line of the hydraulic pump, and by its second connection to the second connection of the first partial delivery line of said hydraulic pump.

5. Hydrostatic drive system according to claim 3, wherein a fifth hydraulic motor which drives a third drive line is connected by its first connection to the first connection of the first partial delivery line of the hydraulic pump, and by its second connection to the second connection of the second partial delivery line of said hydraulic pump.

6. Hydrostatic drive system according to claim 5, wherein a sixth hydraulic motor, which drives the third drive line in a manner mechanically coupled to the fifth hydraulic motor, is connected by its first connection to the first connection of the first partial delivery line of the hydraulic pump, and by its second connection to the second connection of the first partial delivery line of said hydraulic pump.

7. Hydrostatic drive system according to claim 6, wherein the second hydraulic motor, is connected by its first connection to the first connection of the second partial delivery line of the hydraulic pump, the fifth hydraulic motor is connected by its first connection to the first connection of the first partial delivery line of said hydraulic pump, and the sixth hydraulic motor is connected by its first connection to the first connection of the first partial delivery line of said hydraulic pump.

8. Hydrostatic drive system according to claim 5, wherein a seventh hydraulic motor, which drives a fourth drive line is connected by its first connection to the first connection of the second partial delivery line of the hydraulic pump, and by its second connection to the second connection of the first partial delivery line of said hydraulic pump.

9. Hydrostatic drive system according to claim 8, wherein an eighth hydraulic motor, which drives the fourth drive line in a manner mechanically coupled to the seventh hydraulic motor, is connected by its first connection to the first connection of the second partial delivery line of the hydraulic pump, and by its second connection to the second connection of the second partial delivery line of said hydraulic pump.

10. Hydrostatic drive system according to claim 1, wherein if necessary, an equalizing flow for equalizing a differential takes place, in each case, between the two partial flows of hydraulic fluid in the two particular working conduits which are connected, in each case, to the two first or second connections of the hydraulic pump.

11. Hydrostatic drive system according to claim 10, wherein the equalizing flow between the two partial flows of hydraulic fluid is realized, in each case, via a 2/2-way valve which is connected between the two working conduits and which is closed if necessary.

12. Hydrostatic drive system according to claim 11, wherein one of the two 2/2-way valves is integrated into the hydraulic pump on the feeding-in and feeding-out sides in each case.

13. Hydrostatic drive system according to claim 1 wherein the hydraulic pump is designed as an adjusting pump.

14. Hydrostatic drive system according to claim 1 wherein each hydraulic motor is designed as a fixed-displacement motor, a torque motor and/or an adjusting motor.
